(19) United States
(12) Patent Application Publication
(10) Pub. No.: US 2009/0192929 A1
(43) Pub. Date: Jul. 30, 2009

(54) Systems and Methods for Distributing Electronic Media

(76) Inventors: Jonathan William Hoeflinger, Dinuba, CA (US); Marlon Henderson, JR., Jonesboro, AR (US); James Michael Leath, II, Fresno, CA (US)

Correspondence Address: ARNOLD & PORTER LLP;ATTN: IP DOCKETING DEPT., 555 TWELFTH STREET, N.W., WASHINGTON, DC, 20004-1206, US

(21) Appl. No.: 12/354,661

(22) Filed: Jan. 15, 2009

Related U.S. Application Data
(60) Provisional application No. 61/023,155, filed on Jan. 24, 2008.
(60) Provisional application No. 61/107,277, filed on Oct. 21, 2008.
(60) Provisional application No. 61/107,984, filed on Oct. 23, 2008.

(51) Int. Cl. G06Q 40/00; G06Q 30/00

(52) U.S. Cl. 705/35; 705/14

(57) ABSTRACT

A system and method for the distribution of electronic media content to consumers is disclosed. A portal for the distribution of media content and advertisements to a user's device is provided. Media content and advertisements are displayed on the user's device such that the user views the advertisement while engaging with the media content. An administrative system coordinates the relationships between media content providers, advertisers, and users, and the receipt and provision of content throughout the system. The system and method disclosed provide for a cost-per-time advertising model, wherein the advertiser is charged an advertising fee as a function of the length of time that the advertisement is displayed to the user.

### CROSS-REFERENCE TO RELATED APPLICATIONS

This application claims the benefit under 35 U.S.C. § 119(e) of U.S. provisional patent applications Ser. No. 61/023,155, filed Jan. 24, 2008; Ser. No. 61/107,277, filed Oct. 21, 2008; and Ser. No. 61/107, 984, filed Oct. 23, 2008; all of which are hereby incorporated by reference in their entirety.

### TECHNICAL FIELD

The present disclosure relates generally to the distribution of electronic media. More specifically, the present disclosure relates to systems and methods for distributing electronic media at no out-of-pocket expense to end users in conjunction with the display of advertising during the distribution of such electronic media.

### BACKGROUND

With the increased availability of the Internet, electronic media content, such as music, movies, television shows, and books, has increasingly been placed online. In many cases, that media content can be pirated, stolen and distributed over the Internet in a way that musicians, producers, authors, and the industries which represent them, cannot, at present, monetize.

The first wave of piracy through transferring media content electronically online mainly affected the music industry. This was due primarily to the advent of compression and decompression algorithms (also known as “codecs”) that enabled traditionally large size music files (commonly referred to as “wave” or “.wav” files) to be compressed into relatively small files, such as MPEG-1 audio layer 3 (“.mp3”) files. These codecs reduce the amount of data required to represent an audio recording while enabling a computer processor to play back the file without much if any perceived loss in audio quality. While the transfer of a wav file from one computer to another over a network connection could take hours, the availability of .mp3s enabled the exchange of music in a manner of minutes (or less) over the Internet. As technology and the speed of the Internet has improved over the years, it has become increasingly easier to transfer larger forms of electronic media content such as full length movies, videos and even streaming television programs.

The general ability by a large majority of consumers to transfer electronic media content over the Internet has created serious revenue problems for original content developers in the music, movie, television, and similar industries. To this day, none of these industries have been able to harness the large quantity of electronic media content transfers through the Internet. Instead, each respective industry has endeavored to control or even stop the exchange of electronic media content through the Internet. For example, Google was served with a one billion dollar copyright lawsuit from VIACOM after purchasing YouTube, which enables users to post videos that anyone can stream. The lawsuit alleges that YouTube infringes various copyright lawsuits by allowing its users to post, share and play copyright protected material through its web site. In a similar instance, the music industry, through the Recording Industry Association of America (“RIAA”), has sued college students and home users all across the United States for allegedly illegally downloading and sharing online music media files. In both cases, VIACOM and the RIAA are attempting to collect royalties for each exchange of the electronic media content.

The resulting question for the advertising, entertainment, music, and similar industries (collectively the “media industry”) is how to monetize the transfer of electronic media content over networks, such as, for example, the Internet. In one aspect, the answer seems very basic: sell electronic media content to the public through online resources such as the Internet. Unfortunately, the original model for acquiring online media content was through peer-to-peer (P2P) networks, such as Napster in the late 1990's, which enabled consumers to obtain and share electronic media content for free. Now, purchasing electronic media content online seems counterintuitive to most people given that for many years consumers have largely been able to obtain electronic media content for free. Despite the many lawsuits brought against Napster, other P2P networks, and individuals by the media industry and copyright owners, consumers can still readily obtain electronic media content for free through the Internet. Those consumers who do pay for music cannot ignore the overwhelming fact that the electronic media content is so readily available for free throughout the Internet that, in essence, it “doesn't feel like stealing.” Thus, the media industry as a whole is faced with an environment in which consumers do not want to pay for electronic media, and technology which enables consumers to do just that.

Because consumers are now more than ever able to watch and distribute electronic media content in a way that does not result in payment back to the media content owner, the media industry is experiencing a continuous downward spiral of revenue. At present, this is particularly visible in the music industry. Moreover, as consumers continue to increasingly receive entertainment-related content through electronic and/or networked distribution (e.g., the Internet), the demand for physical multimedia, such as CDs, DVDs and books sold in retail stores continues to diminish. This, in turn, results in a decreasing amount of media content being created and provided to the public: The Hollywood writers' strike, decreasing quantities of new artists introduced into the marketplace, a significant and continuing drop in television viewing, thousands of worker layoffs at a variety of entertainment companies, and entertainment companies closing stores and/or going out of business can all be attributed, at least in part, to the diminished revenue returns the media industry receives from the old system of distributing multimedia content. As more people gain accessibility to the Internet, the profitability of selling and distributing media content through traditional brick and mortar retail stores may become decreasingly feasible with time.

Despite the foregoing, the advertising industry continues to grow and succeed online. Online advertising continues to move toward a system that places less risk on the advertiser and more risk on the publisher (i.e. the content owner) of the web site. The first online advertising model comprised advertisements that streamed across a page. Advertisers paid the web site owner as a function of the number of views of a webpage displaying the advertisement, known as the cost-per-thousand or “CPM” model. Eventually, advertisers realized that the Internet had an added function that traditional advertising (e.g. radio, television, billboards, etc.) did not: a consumer could “click” the advertisement and visit the corresponding web site of the advertiser. As a result, advertisers only wanted to pay for those users who clicked on the particular advertisement, creating a cost-per-click or “CPC” advertising model. The CPC model gives advertisers a more quantifiable method for determining the value of the advertisement. While advertisers tend to prefer this model, web site owners have been reluctant to move to the CPC model because it shifts the risk away from the advertiser and on to the web site owner. Web site owners must shoulder the risk for an advertiser who advertises a bad or unpopular product.

Web site owners began comparing the performance-based CPC model to the initial CPM model. The comparison endeavored to generate comparable revenue for the web site owner based on either the CPC model or the CPM model. Typically, the result of one thousand advertisement views by a consumer translated to one dollar to two dollars of revenue to the web site owner. This information enabled advertisers to determine which web sites best suit a particular form of advertising model. Web sites that have a high volume of traffic could continue operating under the CPM model, while the performance-based CPC model was the only way lower traffic websites could obtain advertising revenue from advertisers.

The advertisement industry also soon realized that not all advertisement placements were equal. Rather, the location of an advertisement on a web page could be crucial and even determinative of whether a user actually clicked on the advertisement. Advertisements placed at the top of a scrollable web page (e.g., a search engine results page) would receive more clicks than the corresponding advertisement placed at the bottom of the web page. While the owner of the advertisement placed at the bottom of the web page has a viable complaint based on the placement of the advertisement relative to an advertisement placed at the top of the web page, this system of placing advertisements was simply a result of the accepted scrolling design and format of a typical web page.

In another aspect of online advertising, advertisers became increasingly reluctant to pay for just “clicks” under the CPC model. Advertisers began conditioning payment on clicks that convert into actual sales. In view thereof, consumers are required to engage with the advertiser beyond simply clicking on the advertisement and going to the advertiser web page. New advertising models such as cost-per-action (“CPA”) and cost-per-lead (“CPL”) developed in view of these new principles. In the CPA model, advertisers place advertisements on a web page and are only required to pay the web site owner if a consumer purchases goods and/or services from the advertiser. Advertisers accordingly pay the web site owner a percentage of the sales generated through the advertisement. Tracking technology was deployed to monitor the consumer after the consumer clicked on a particular advertisement and any goods or services purchased through the advertiser. Accordingly, the owner of the web site on which the advertisement was placed would receive a portion of the revenue created from the sale. In the CPL model, web site owners host a portal in which advertisers compete with one another to advertise on the web site and ultimately obtain the business of the consumer. In other words, the web site owner is used to create business leads for the advertiser. The advertiser then reimburses the web site owner upon events such as the completion of a sale, start of a service, or joining of a sweepstakes. In this model, the web site owner is a middleman or a sales representative for the advertiser. Both the CPA and CPL models essentially take all the risk out of advertising for the advertiser.

Harnessing advertising with respect to electronic media content has been especially difficult online as the Internet is always, and very rapidly, changing. The media industry has struggled for years to rectify the rapid and constantly increasing piracy rate for electronic media content. At best, members of the entertainment industry have offered several poor solutions to this problem. For example, musicians and bands have resorted to giving music away for free in hopes of later obtaining revenue by selling tickets to live concerts and selling merchandise. Other musicians post music online and request that fans download the music and pay “whatever you like.” Large music entities, such as the RIAA, have sued the public for downloading and distributing electronic media content without authorization. Each of these methods search for an answer to distribution problems, but none of these concepts provide the desired solution: compensation to the media content owner for the development and distribution of the electronic media content within a framework that consumers will accept and use.

Thus, there is a need for a system that can simultaneously monetize the transfer of media content, make it freely available to the consumer in order to harness the culture mindset, and advantageously use current technology to drive sales of the electronic media content. Media producers and developers should receive adequate compensation for their innovations, and should be encouraged to produce more novel works. The present disclosure fulfills these needs and provides further related advantages.

### SUMMARY

The present disclosure provides systems and methods for the distribution of electronic media content to consumers. Those who wish to obtain media content at no out of pocket expense, but legally and with valid copyright licenses, may engage with one or more advertisements while viewing the media content. The advertisements and the media content may be placed such that the user cannot view the media content without simultaneously viewing the advertisements. An administrative system coordinates the relationships between media content providers, advertisers, and users, and the receipt and provision of content throughout the system. Advertising revenue generated through this system may be distributed back to the administrator, the media content providers, users, and other individuals, as desired.

Rather than relying on old advertising revenue models, such as the CPM, CPC, CPA, and CPL models, the present disclosure provides a new advertising model—cost-per-time. Users are actively exposed to advertising content because those users want to obtain the media content simultaneously displayed. As the number of users increases, advertisers are also incentivized to place more advertising at higher rates, generating more advertising dollars that users may receive as value for engagement with or exposure to the advertisements. This media distribution model further incentivizes media content providers to provide media content for distribution because the providers can receive payment in exchange for their works. Finally, users' incentives to illegally download or pirate electronic media content are eliminated under this model, because they can receive media content without incurring any out-of-pocket expenses for the media content.

### BRIEF DESCRIPTION OF THE DRAWINGS

The drawing figures depict one or more implementations in accord with the present concepts, by way of example only, not by way of limitations. In the figures, like reference numerals refer to the same or similar elements:

FIG. 1 is a schematic representation of a distribution system for the free distribution of electronic media content to users.

FIG. 2 is a block diagram of one embodiment of the distribution system for the free distribution of electronic media content to users.

FIG. 3 is a block diagram of an exemplary login interface for a user to log into the distribution portal.

FIG. 4 is a block diagram of an exemplary display when a user has logged into the distribution portal.

FIG. 5 is a flow chart of an exemplary method for accruing and redeeming points in a points bank.

FIG. 6 is a flow chart of an exemplary method for accruing and redeeming points in a points bank.

### DETAILED DESCRIPTION

The present disclosure provides systems and methods for the distribution of electronic media content that is free to the consumer.

Several aspects of the embodiments described herein will be illustrated as software programs or components stored in a computing device. As used herein, a software program or component may include any type of computer instruction or computer executable code located within a memory device and/or transmitted as electronic signals over a system bus or network. A software program may, for instance, comprise one or more physical or logical blocks of computer instructions, which may be organized as a routine, program, object, component, data structure, etc., that performs one or more tasks or implements particular abstract data types.

In certain embodiments, a particular software program may comprise disparate instructions stored in different locations of a memory device, which together implement the described functionality of the program. Indeed, a program may comprise a single instruction, or many instructions, and may be distributed over several different code segments, among different programs, and across several memory devices. Some embodiments may be practiced in a distributed computing environment where tasks are performed by a remote processing device linked through a communications network. In a distributed computing environment, software programs may be located in local and/or remote memory storage devices.

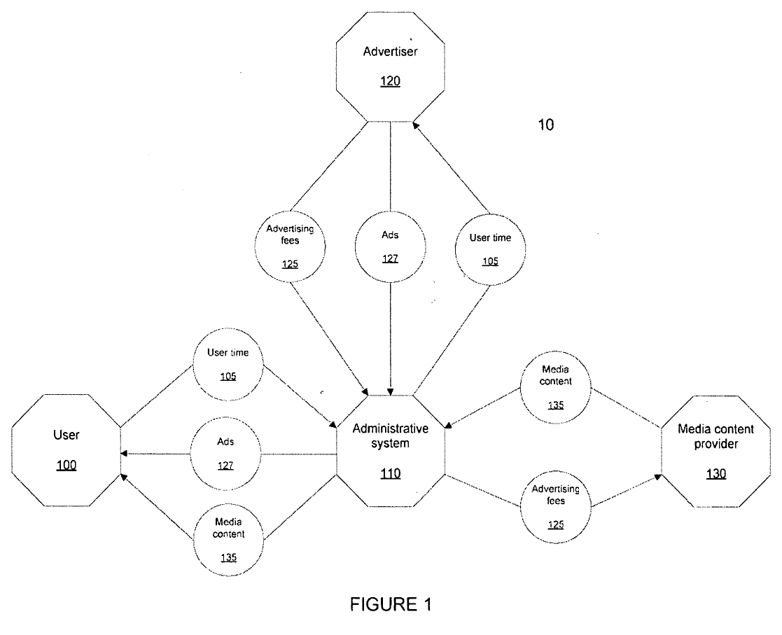

In accordance with the embodiments described in greater detail below, and as shown schematically in FIG. 1, the systems and methods disclosed herein create a media distribution system 10 through which one or more users 100 may acquire electronic media content 135 in exchange for engaging with or being exposed to one or more advertisements 127 delivered by an advertiser 120 through an administrative system 110. Advertising fees 125 obtained from one or more advertisers 120 may be divided according to a predetermined formula among the owner and/or administrator of the administrative system 110, media content providers 130, users 100, other individuals or entities, or any combination thereof. The media distribution system 10 incentivizes one or more media content providers 130 to provide media content 135 for distribution through the administrative system 110 because the providers 130 receive payment in exchange for their works 135, and eliminates users' 100 incentive to illegally download or pirate electronic media content 135 because they can acquire electronic media content 135 for free. As the number of users 100 increases, advertisers 120 are also incentivized to place more advertising 127 through the distribution system 10 at higher rates, generating more advertising dollars 125 that may be divided among various constituencies of the system 10.

A media content provider 130 may be any person who generates, owns, licenses, or otherwise possesses media content 135. For example, media content providers may be, but are not limited to, musicians, artists, producers, music labels, television studios, authors, and/or any other person or entity that has the authority to distribute, sell and/or license the media content. Media content 135 may include, but is not limited to, music, movies, news, original programming, advertisements, independent and/or original works, television shows, music videos, video games, web log (aka blog) postings, and electronic books (also referred to as e-books). As appropriate, the media content provider 135 can be required to state, confirm and/or provide proof that he/she has the authority or represents the party that has the authority to allow distribution of the media content through the system 10.

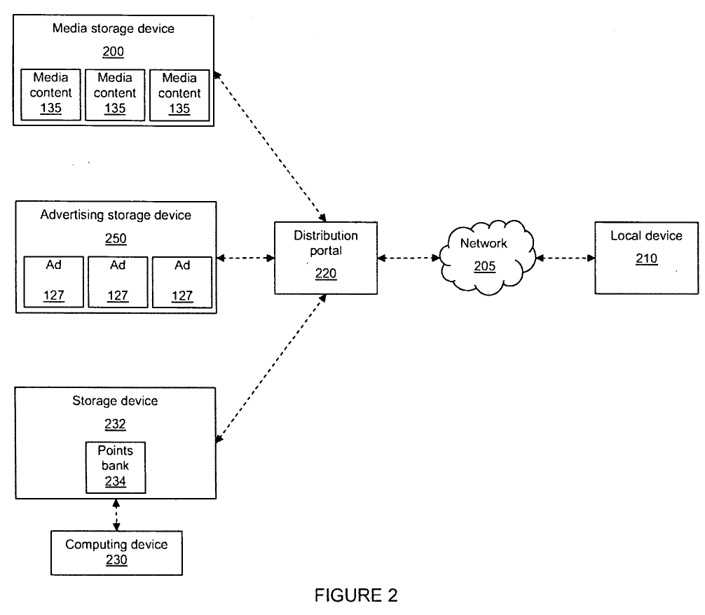

FIG. 2 is a block diagram of an exemplary embodiment of the system 10. As shown, the system may comprise at least one media storage device 200 for the receipt and storage of media content 135. Such a media storage device 200 may be one or more computers, servers, databases, or other devices capable of (either individually or collectively) storing electronic media content and communicating with other electronic devices. As necessitated by storage capacity and other practical considerations, media content 135 may be stored in multiple media storage devices 200.

The embodiment may also comprise at least one advertising storage device 250 for the receipt and storage of at least one advertisement 127, which may be a graphic or an image, a moving picture, video, or audio, as desired by the advertiser. The advertising storage device 250 may be one or more computers, servers, databases, or other devices capable of (either individually or collectively) storing electronic advertising content and communicating with other electronic devices. As necessitated by storage capacity and other practical considerations, advertisements 127 may be stored in multiple advertising storage devices 250.

A user 100 (not shown) interacts with the system through a distribution portal 220 using an electronic device 210. The distribution portal 220 may be, but is not limited to, a web site or web portal which may be accessed by the user 100 through a web browser program or the like running on the device 210. The electronic device 210 may be, but is not limited to, a personal computer (either desktop or laptop), a personal digital assistant, a cellular telephone, a multimedia content player (such as an iPod or Zune device), a television (with or without a set-top-box), a digital video recorder, a networked video player, or some other similar type of device. The device 210 may communicate with the distribution portal 220 through any appropriate network or direct connection including, but not limited to, the Internet, a local area network, a wide area network, a cellular network, a satellite link, a direct connection, and/or any combination thereof. Through the distribution portal 220 the device 210 may gain access to (either directly or indirectly) the stored media content 135 on the media storage device 200 and/or the advertising 127 on the advertising storage device 250. Accordingly, a user 100 may use the device 210 to access media content 135 stored on the media storage device 200, to view and/or listen to that media content 135 on a device 210, to download or copy media content to the device 210 or another device, and/or to view or listen to advertisements 127 on advertisement storage device 250.

The embodiment of FIG. 2 may further comprise one or more computing devices 230 (such as a computer, server or the like) and/or storage devices 232 (such as a database, hard drive, file server or the like) as necessary for implementing the functionality of the system. As one example, the computing device 230 and storage device 232 perform the tasks necessary to allow a user to engage with the system (e.g., register and/or log-in); to operate the distribution portal (e.g., to act as a web server to send the distribution portal's web pages to the user's device and receive information back from the user and/or the user's device); to keep track of the amount of time that a user 100 has engaged with the distribution portal and/or advertisements 127; to record and compute information about the media content 135 that a user has viewed, listened to, downloaded or otherwise interacted with; to credit and/or debit points from the user's points bank 234; and/or other tasks that may be appropriate or necessary for the operation of the system 10.

It is to be understood that the various components described herein and the functions attributed to them may be divided among one or many devices. For example, the system may use more than one media content device 200 or advertising storage device 250, or a single device may act as both a media storage device 200 and advertising storage device 250. As another example, the functionality of the distribution portal 220 may be divided between one or more physical devices. As yet another example, the functionality of the computing device 230 and storage device 232 may be performed by the same device. It is to be understood that the examples recited here are not intended to, and do not, limit the manner in which the functionalities of the system may be divided among the one or more hardware devices and/or software modules comprising the system. It is further to be understood that the system as described herein does not in any way limit the manner in which one of the hardware or software components of the system may communicate or otherwise exchange information or data with another component of the system.

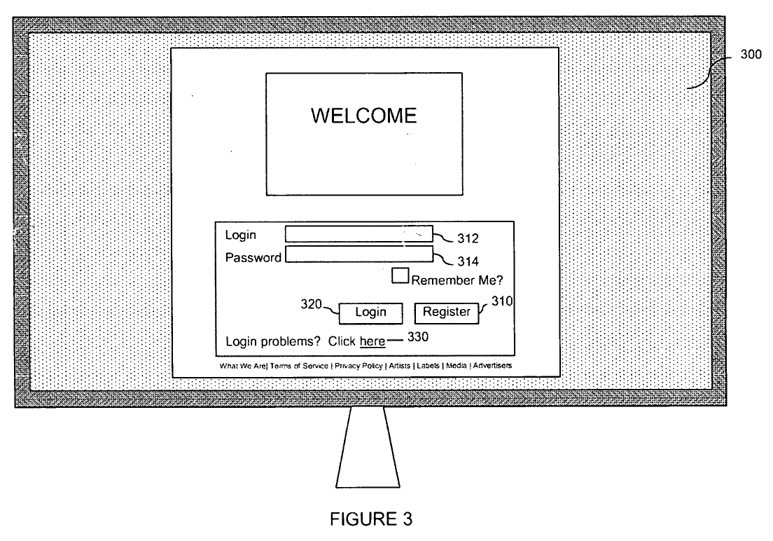

Prior to accessing the distribution portal 220, the user 100 may be required to register with the distribution portal 220. The user 100 may be required to submit information such as his or her e-mail address, a password, general demographic information such as age and gender, geographic location, any other relevant or useful information, or any combination thereof. Following registration, the user 100 may be required to log into the distribution portal 220 using his or her registered credentials each time the user 100 wishes to access media content 135. A block diagram of an exemplary screen 300 for registering with or logging-in to the distribution portal 220 is shown in FIG. 3. A user 100 may select the register option 310 to register with the system, at which point the user will be directed to one or more screens (not shown) to provide his or her registration information. Methods and systems for allowing a user to register with a distribution portal are well-known and will not be discussed in detail here. Alternatively, if already registered, a user 100 may enter login name 312 and password information 314 and select the login option 320 for logging into the distribution portal 220. The exemplary screen may also include one or more options for addressing login problems 330 and one or more options to select information related to terms of service, privacy policy, artists, labels, media, advertisers, information about the distribution portal, and/or any other information that may be appropriate or desired. It is to be understood that the login screen 300, and the manner in which a user 100 is permitted to register or log into the system, or the type of information that may be displayed or accessible from the screen 300 is not limited in any way.

In one embodiment of the disclosure, other constituencies of the system 10 may also be required to register and log-in when they wish to interact with the system 10. For example, an advertiser 120 may register and log in before submitting advertisements for distribution to users through the distribution portal 220, and/or a media content provider 130 may register and log in before submitting media content to be distributed to users 100 through the distribution portal 220.

When a user 100 logs into the distribution portal 220, the distribution portal 220 may display a wide variety of information on the user's device 210. As one example, the distribution portal 220 may display selected media content 135 on the device 210. As another example, the distribution portal 220 may display information relating to the popularity of specific media content, such as “top 10” lists or the like on the device 210. The distribution portal 220 may also display community information, such as media content 135 relevant to the user's geographic region or content preferences. As yet another example, the distribution portal 220 may display a user's profile or credential information, or public information about other users on the device 210. If the user 100 has previously accessed the distribution portal 220 to access media content 135, the distribution portal 220 may display information about that content 135, such as playlists of all or a portion of the previously-accessed content 135. It is to be understood that this information is not mutually exclusive, and there is no limit in the content of the information that may be displayed by the distribution portal 220, or the manner and/or format in which the information is displayed or presented on the device 210.

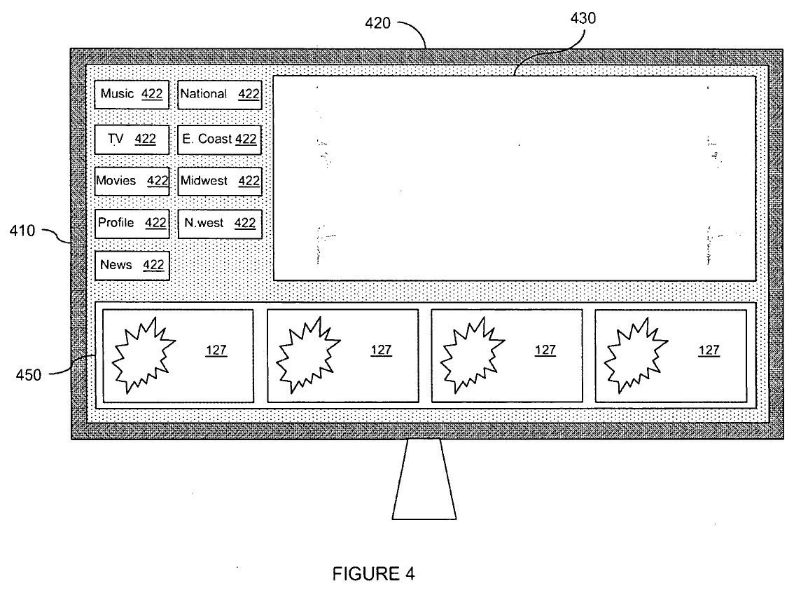

FIG. 4 is a block diagram of an exemplary representation of the information and/or content that may be displayed on a device 210 after a user has logged into the distribution portal 220. In this exemplary embodiment, the device 210 is a personal computer (not shown in its entirety) with a display 410 running a web browser program (such as Internet Explorer, Safari or Firefox) for displaying one or more web pages 420 used to access and communicate with the distribution portal 220. It is to be understood that the disclosure is not limited to use of a web browser and any appropriate interface and/or protocol may be used to communicate with, and display information received from, the distribution portal 220.

In the exemplary embodiment of FIG. 4, the web page 420 is non-scrollable, such that the entirety of the content provided by the distribution portal 220 to be displayed on the screen 410 is viewable on the screen 410 without the user 100 having to scroll down or up in order to view the content and/or information. By way of example and not limitation, the web page 420 may comprise one or more links or buttons 422 for gaining access to various communities comprising the distribution portal 220, a content display section 430 for displaying or playing information and/or media content 135 as appropriate and based on selections made by the user 100, and a section 450 for displaying one or more advertisements 127.

As one example, the web page 420 may include a link that allows the user 100 to gain access to a section of the distribution portal 220 for browsing and/or listening to music, a link that allows the user 100 to gain access to a section of the distribution portal 220 for browsing and/or viewing TV shows, a link that allows the user I 00 to gain access to a section of the distribution portal 220 for browsing and/or viewing movies, a link that allows the user 100 to gain access to a section of the distribution portal 220 for browsing, viewing and/or editing the user's own profile information, or to browse the profiles of other users, a link that allows the user 100 to gain access to a section of the distribution portal 220 for browsing and/or viewing news, and one or more links to allow the user 100 to gain access to one or more sections of the distribution portal 220 that display content and/or information that pertains to specific geographic regions (e.g., the most popular media content in that specific geographic region). It is to be understood that the links discussed herein are exemplary and are not intended to limit the type or number of links that may be displayed on the device 210 or accessed by the user 100, and/or to limit the type or number of communities or sections that comprise the distribution portal 220.

As the user 100 selects one or more links 422, the appropriate information that is retrieved by the link is displayed on a section 430 of the web page 420 that changes based on the information requested by the user 100. For example, if the user 100 selects the movies link 422, the section 430 of the web page 420 may display information related to movies, such as movies that may be available for viewing and/or download, top 10 or similar types of list, or the like. If a user 100 elects to view a particular movie, then the section 430 of the web page 420 displays an appropriate movie player to display the movie. If instead, a user 100 selects the music link 422 and elects to listen to a particular song, then the section 430 of the web page 420 may display an appropriate music player to play the song.

One or more advertisements 127 may be displayed in section 450 of the web page for displaying advertisements. Because of the non-scrollable nature of the web page 420, the one or more advertisements 127 displayed in the advertisement section 450 will be viewable the entire time that a user 100 interacts with the distribution portal 220 through the links 422 and content display section 430. For example, while the user 100 views or listens to a first media content 135, the user will also be able to view advertisements 127. If the user 100 decides to view or listen to a second media content 135, the information in the content display section 430 will change (e.g., a the movie player will play a different movie in the content display section 430) but the advertisements 127 displayed in the advertisement section 450 will still be viewable. Thus, as a user 100 navigates through the various sections of the distribution portal 220, the content and/or information displayed in the display section 430 and/or the links 422 may change, but the advertising section 450 remains visible to the user 100 and advertisements 127 may continue to be displayed to the user 100 while the user 100 interacts with the distribution portal 220. Accordingly, the advertisements 127 need not be embedded into or placed in between the media content 135 (e.g., playing an advertisement in between segments of the media content) or placed over the electronic media content 135 (also referred to as overlaying an advertisement on the media content), as is the current practice in some online web sites and on network television.

In the example of FIG. 4, a user 100 may view one or more advertisements 127 concurrently with viewing the media content 135 or while otherwise interacting with the distribution portal 220. In one embodiment, one or more advertisements 127 displayed in the advertising section 450 may change at specific time intervals while the user 100 views or listens to the media content 135 or otherwise interacts with the distribution portal 220. By way of example and not limitation, if the user 100 selects a three-and-a-half minute music video, the advertisement(s) 127 may change every thirty seconds (or seven times), while the user 100 views the music video. If four advertisements 127 were simultaneously placed in the advertising window 450, and those advertisements 127 were changed every thirty seconds, the user 100 would view twenty-eight different advertisements 127 while viewing the music video. Of course, it is to be understood that if multiple advertisements 127 appear at the same time, each advertisement 127 may change or be replaced on a different schedule. In other words, advertisements 127 need not be replaced simultaneously.

In one embodiment of the disclosure, the distribution portal 220 may be organized such that parts of the portal are scrollable and others are not. Referring to the exemplary block diagram of FIG. 4, the web page 420 may be organized such that the display section 430 and the section displaying the links 422 may be scrollable, but the advertisement display section 450 is non-scrollable. In such an embodiment, even though a user may scroll through the content displayed in section 430, the advertisements 127 displayed in the advertisement display section 450 remain viewable to the user and the user may not navigate away from the advertisements while engaging with the distribution portal 220.

It is to be understood that the interface through which the user interacts with the distribution portal 220 need not occupy the entire physical screen 410 of the device 210. For example, in the exemplary embodiment of FIG. 4 in which the user interacts with the distribution portal 220 through a web browser running on the local device 210, the browser window on which the web pages 420 are displayed need not occupy every pixel of the display 410. In other words, the generally non-scrollable web page 420 (and/or the window in which it appears) may be of any appropriate size and need not (but may) occupy every pixel on the display 410.

In one embodiment of the disclosure it may be preferable to charge the advertiser 120 an advertising fee 125 for the display of an advertisement 127 within the distribution portal 220. This advertising fee 125 may be calculated as a function of the amount of time that the advertisement is displayed on the device 210 through the distribution portal 220. This system and method of charging a fee for advertisements may also be referred to as a “cost-per-time” (“CPT”) model. Because of the substantially non-scrollable nature of the distribution portal 220 as displayed on the device 210, advertisements 127 can be displayed while a user 100 spends time engaging with the distribution portal 220, whether viewing or listening to media content 135, browsing top 10 lists or the like, updating profile information, viewing other users' profile information, viewing information other than media content, or any other type of interaction or engagement with the distribution portal 220.

Time spent within the distribution portal 220 may be calculated as a background process; in other words, the distribution portal 220 records time for the user 100 so long as he or she is accessing media content 135 or otherwise engaging with the distribution portal 220. Alternatively, the distribution portal 220 may be configured to require the participation of the user 100, such as, for example, by clicking on a button at regular intervals to signal to the distribution portal 220 that the user 100 is still engaged. It is to be understood that other techniques for ensuring that the user 100 remains engaged with the distribution portal 220 may be available and the present disclosure does not in any way limit the methods or techniques that may be used to determine whether and the amount of time that a user 100 remains engaged with the distribution portal 220.

Advertising rates may be set during a “sweeps” period, much like they are set with respect to television advertising rates. In a sweeps period, an advertiser 120, the administrative system 110, or another appropriate party may survey a group of one or more users 100 to assess user-related statistics, such as, for example, the average time each user 100 spends engaged with the distribution portal 220, user demographics, peak usage periods (including time of day and time of the year), and/or any other information helpful in setting advertising rates. Advertising rates may also be set based on the nature of any media content 135 viewed. In one embodiment of the disclosure, advertising rates may be fixed so that in the average time it takes to view or listen to the media content 135 a sufficient number of advertisements 127 can be displayed to generate sufficient advertising revenue 125 to adequately compensate media content providers 130 and ensure that the system remains both solvent and profitable. For example, if the average song is three and a half minutes long, and four advertisements 127 at a time are displayed for thirty seconds each on the device 210 while the user 100 listens to the song, advertising rates may be set such that the twenty eight advertisements 127 that are displayed while the song plays generate sufficient revenue to compensate the media content owner 130 for the song and to leave sufficient revenue for the system owner to maintain the system profitably.

The advertising fee 125 may be further calculated as a function of whether the user 100 chooses to view information related to the advertisement 127 but not actually contained within the advertisement 127. For example, if the user 100 were to click on an advertisement 127 displayed on the device 210 while viewing a music video, the click may result in the user 100 being directed to the advertiser's web site, and the advertiser 120 may be charged an additional component to the advertising fee 125. Alternatively, selecting an advertisement may result in additional information about the item advertised to be displayed in the distribution portal 220 (e.g., in the display section 430) without the user being directed to a different web site. Further, if the user 100 chose to purchase an item from the advertiser 120, yet another component could be added to the advertising fee. Accordingly, it is possible to incorporate the CPM, CPC, CPA, and CPL advertising models into the larger CPT model.

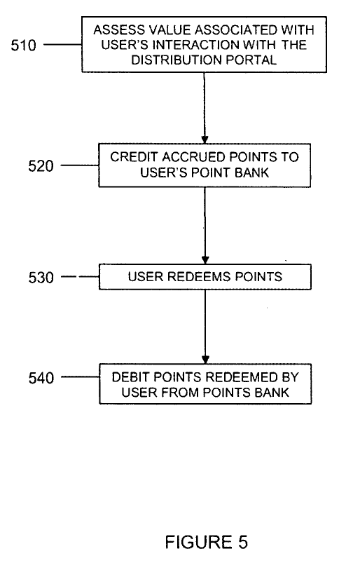

FIG. 5 is a flow chart depicting an exemplary method by which a user 100 may accrue and/or redeem points in a points bank 234. At step 510 the administrative system 110 assess the value associated with the user's interaction with the distribution portal 220. A user 100 may accrue points in the points bank 234 based on the user's engagement with the distribution portal 220. The points accrued by the user 100 may be a function of the time that the user 100 spends interacting with the distribution portal 220, the types of advertisements 127 that are displayed in the advertising section 450 while the user 100 is interacting with the distribution portal 220, the type of media content 135 with which the user 100 engages, the relative popularity of the media content 135 that the user 100 views or hears, the number of advertisements 127 that are displayed while the user 100 is engaged with the distribution portal 220, any other relevant or appropriate criteria, and/or any combination thereof.

In one embodiment, it may be preferable that after viewing or listening to a particular media content 135 (e.g., after listening to a whole song or viewing a whole movie), the user has accumulated sufficient points in his or her points bank 234 to be able to download or copy the media content 135 to the device 210 or another device as desired. However, the user 100 need not use the accrued points to download the same media content 135 through which the user 100 accrued the points. For example, the user 100 may listen to a first song and use the points accrued while listening to the song to download a different song.

In one embodiment, a user 100 may accrue additional or extra points for viewing media content 135 that commands premium advertising rates, or for which the media content provider 130 agrees to provide the user 100 with additional or extra points as an incentive for users 100 to engage the media content 135.

In another embodiment, the number of points accrued by a user 100 for viewing particular media content 135 may be derived from the value of advertising revenue received through the administrative system 110. For example, a first item of media content 135 may command premium advertising rates because it may be extremely popular, and numerous advertisers 120 may desire to place their advertisements 127 in association with that particular item of media content 135. A second item of media content 135 may command lower advertising rates because it may be less popular, and attract fewer advertisers 120 who wish to place their advertisements 127 in connection with that particular item of media content 135. One may design a system according to the present disclosure in which a user accumulates more points in the points bank 234 for engaging with the first item of media content and accumulates less points in the points bank for engaging with the second item of media content.

It is to be understood that the present disclosure is broad enough to encompass any implementation of an account, file, data and/or system for recording and/or tracking a user's interaction with the system. Thus for example, and not by way of limitation, instead of accruing points a user may accrue shares, currency, a currency equivalent or any other metric that may serve as a proxy for and/or track the user's interaction with the system or the distribution portal.

At step 520, the points accrued by the user through interacting with the distribution portal 220 are credited to a user's points bank 234. The points bank 234 may be maintained by the administrative system 110, for example, on a storage device 232, or it may be maintained on the user's device 210, or it may be maintained on both the storage device 232 and the user's device 210. If stored on the device 210, the user 100 may be able to check the balance of the points bank 234 even when the user 100 is not logged into or otherwise engaged with the distribution portal 220.

At step 530, the user 100 may be permitted to redeem the points accrued in the points bank 234. In one embodiment the user 100 may use the points accrued in the points bank 234 to obtain copies of media content 135 to be downloaded to a device 210 with a valid copyright (or other intellectual property, as applicable) license. If the user 100 chooses to redeem points in this manner, the user 100 may be able to later view or listen to the downloaded media content without being logged into or otherwise engaged with the distribution portal 220. The system and method of the present disclosure may use secure transfer or encryption technology, digital rights management technology, water marking technology, or any other appropriate technology to ensure that downloaded copies of media content 135 are used in compliance with the terms of the license granted to the user 100.

When a user 100 redeems points in his or her points bank 234 to download or otherwise receive a copy of a media content 135, the advertising fees 125 that were generated while the user 100 was accruing the points may be split between the media content provider 130 and the owner and/or administrator of the administrative system 110 and distribution portal 220, any other entities as appropriate, and/or any combination thereof. In this manner, the media content provider 130 receives compensation for the transfer of electronic media content 135 while the owner of the distribution system generates revenue for the continued operation of the distribution system 10. The percentage and/or amount of the advertising revenue that is paid to the media content owner 130 may be a function of the length (measured in time) of the media content 135, the number of advertisements 127 displayed while the user 100 engaged with the media content 135, the relative popularity of the media content 135, any other relevant characteristics, or any combination thereof. The owner and/or administrator of the administration system 110 and distribution portal 220 may also be paid a fee as a percentage of the advertising revenue 125 generated through the system 10.

In another embodiment, the user 100 may be permitted to redeem the points accrued in his or her points bank 234 to purchase products or services other than the media content 135 available through the distribution portal 220. For example, the user 100 may be permitted to use points in his or her points bank 234 to obtain products or services offered by the advertisers 120. When a user 100 redeems points in his or her points bank 234 to obtain products or services in the manner described, the advertising fees 125 that were generated while the user 100 was accruing the points may be split between one or more of the advertisers from which the user 100 obtains the product or service, the owner and/or administrator of the administrative system 110, the media content provider 130, any other entities as appropriate, and/or any combination thereof.

In yet another embodiment of the disclosure, the user 100 may choose to redeem the points in his or her points bank 234 for actual currency. This redemption of points for actual currency could take the form of, but is not limited to, cash, a rebate check, a preloaded debit or credit card, a deposit in a PayPal or similar account, a deposit in a traditional bank account, or as a credit against an outstanding bill, such as a cable bill. When a user 100 redeems points in his or her points bank 234 to obtain currency in the manner described, the advertising fees 125 that were generated while the user 100 was accruing the points may be divided among the user 100, the owner of the administrative system 110, the media content provider 130, any other entities as appropriate, and/or any combination thereof.

When the user 100 redeems some or all of the points in his or her points bank 234, at step 540 the user's points bank 234 is debited so as to reflect the balance of the points bank 234 after subtracting the points redeemed.

In one embodiment of the disclosure, because the total number of advertisements 127 that may be placed by advertisers 120 may vary during predetermined time periods (e.g., from one week to another, from one month to another, etc.), and because the amount of advertising fees 125 that may be charged for the advertisements 127 during any given time period may vary (e.g., the advertising rates as set by a first sweeps period may differ from advertising rates as set by a second sweeps period, or the advertising rates during certain times of the day may differ from advertising rates during different times of the day), the amount of advertising revenue that may be provided to media content provider 130 for users' download of its media content 135 may differ from one given time period to another. For example, assume that a user 100 needs thirty points in his or her points bank to download a song to his device 210, and that a user may accumulate those thirty points by interacting or engaging three minutes with the distribution portal 220. Assume further that in a first quarter of the year, the number and duration of the advertisements displayed while a user accumulate thirty points for engaging with the system may generate X dollars in revenue, whereas in a second quarter of the year the number and duration of the adds displayed while a user accumulates thirty points for engaging with the system may generate Y dollars in revenue (where Y may be higher or lower than X). Accordingly, when a user redeems thirty points in a first quarter to download a song, the media content owner 130 will receive a percentage of X dollars, whereas when the user redeems thirty points in a second quarter to download the same song, the media content owner 130 will receive a percentage of Y dollars. In other words, the worth of the media content in any given time period may be a function of the amount of advertising revenue that may be generated during that time period.

According to such an embodiment, it may be desirable to calculate a blended advertising rate per second based on the total advertising revenue generated during a given time period (e.g., during a week, a month, a quarter, etc.). Equation I below sets forth a method of calculating a blended advertising rate:

B=A/T (equation 1)

Wherein:
B=blended advertising rate per second for a given time period (e.g., a particular month, a particular quarter, a particular sweeps period, etc.)
A=total advertising revenue generated during the same time period
T=total time spent by users interacting with the distribution portal during the same time period

Equation 2 below sets forth a method of calculating the revenue attributable to a specific media content during a given time period based on the blended advertising rate obtained from equation 1:

R=B×D (equation 2)

Wherein:
R=revenue attributable to a media content for a given time period
B=blended advertising rate per second for the same time period
D=duration of the media content

The revenue attributable to a particular media content may be split between the media content provider 130 and the owner and/or administrator of the administrative system 110 and distribution portal 220, any other entities as appropriate, and/or any combination thereof as discussed herein.

Equation 3 below sets forth a method of calculating the value of shares accumulated by users during a given time period based on the blended advertising rate obtained from equation 1:

V=B×S (equation 3)

Wherein:
V=value of shares accumulated by a user for a given time period
B=blended advertising rate per second for the same time period
S=number of shares accumulated by a user during the same time period

A user may then redeem the value of the points in his or her points bank to obtain media content, products, or services as described herein.

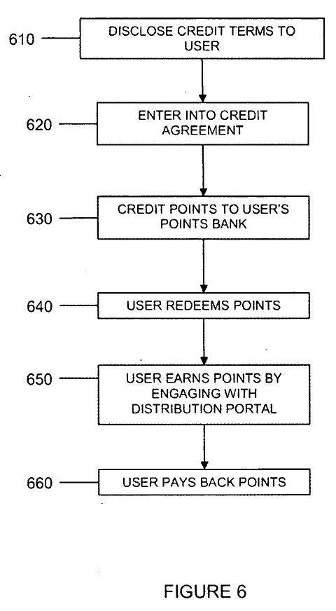

FIG. 6 is a flow chart depicting an exemplary embodiment in which a user 100 is awarded points in his or her points bank 234 before the user has earned the points through his or her engagement with the distribution portal 220, and thereby creating a credit system for earning and using points in a points bank. At step 610, the administrative system 110 either directly or through a third party agent discloses the terms and conditions of a credit agreement to the user 100, including but not limited to, the credit limit and any applicable interest rate. At step 620, the user 100 and the administrative system 110 enter into a credit agreement. At step 630 the administrative system 110 extends credit to the user 100 by, for example, crediting points to the user's points bank 234 that the user 100 has not yet earned through engagement with the distribution portal 220. At step 640, the user 100 may redeem the points awarded to his points bank 234 to acquire any media content 135, or any other products, services or currency that the user 100 would otherwise be able to acquire by redeeming points. At step 650 the user 100 acquires points in his points bank by engaging with the distribution portal 220. At step 660, the user 100 redeems the points he or she has accrued to pay back the points that were credited to his points bank 234 (with or without interest as may be appropriate) based on the terms of the credit agreement.

One advantage of extending credit to users 100 in this manner may be that it creates additional profits for the distribution system 10 by encouraging users 100 to spend more time interacting with the distribution portal 220 in order to repay the credit extended to them. Increasing the amount of time a user 100 spends interacting with the portal 220, in turn, generates more advertising revenue 125 which can be distributed as discussed in greater detail above. Further, if interest payments are assessed, those payments can be distributed to the owner and/or administrator of the administration system 110 and/or the distribution portal 220, media content providers 130, and/or other entities as desired or appropriate.

The systems and methods disclosed herein may provide additional features designed to improve the overall appeal of the system to users 100, media content providers 130, and advertisers 120. For example, the disclosure may provide mechanisms for tracking and recording the demographics of users 100. For example, it may be desirable to collect and store information relating to the geographic distribution of users 100. Geographic regions may be categorized by political boundaries, such as state, county, and city, or other regions as appropriate. For example, in one embodiment of the disclosure, each state may be assigned a number and each county or district may be assigned a letter. Geographic location information may be obtained each time the user 100 accesses media content 135 by, for example, using the IP address of the user's device 210 to determine geographic location. Alternatively, the user's geographic location could be stored as part of a profile associated with a user profile or points bank 234. In yet another alternative, a record may be made of the fact that a user 100 resides in a geographic location without actually associating that fact with the particular user. In this manner, the operator of the distribution portal 220 could store information about the generalized geographic distribution of registered users without saving private details of any particular user. Similarly, each user 100 could provide information about his or her gender and/or age bracket.

A media content provider 130 could be provided some form of access to this demographic information in order to better market his or her media content 135. As one example, a media content provider 130 which is a small music publishing company could use such demographic information to determine where to product place a CD in a retail store. Demographic and geographic information could help an artist to obtain endorsement contracts in a particular region or provide accurate numbers for estimated concert attendances. Advertisers 120 could use this information to target specific geographic regions, particular demographics, and/or consumer preferences. The present disclosure also enables local advertisers 120 to gain access to a local or regional markets without wasting advertising budget on users 100 who, for whatever reason, are unlikely to make use of the advertised product or services. For example, a club promoter could target the surrounding geographic region to advertise an upcoming show.

The distribution portal 220 may also be used by the various participants—the media content provider 130, the advertiser 120, and the user 100—to view relevant statistics about the system. For example, the media content provider 130 may wish to view the number of downloads of that provider's media content 135, the amount of advertising fees 125 payable to the provider 130, and other relevant information as desired. As another example, the advertiser 120 may wish to view the popularity of media content 135 or user preferences.

While many of the examples provided herein focus on web-based distribution portals 220, it should be understood that the systems and methods disclosed herein are applicable in a wide variety of applications. In an alternative example, the system 10 is also applicable to television markets. These markets include, without limitation, network television, satellite television, and cable television. The operators of these television markets could function as the administrative system 110 and implement the CPT model disclosed herein. A television (in conjunction with a set-top-box, digital video recorder, or other hardware as necessary) may function as a distribution portal 220 and a device 210, and one or more advertisements 127 may be displayed at the same time as media content 135, such as a television show. For example, advertisements 127 could be displayed at the bottom of the television screen much like a ticker on a news channel. As in the foregoing examples, the user 100 may create value from exposure to the advertisements 127 based on the CPT model, and the television—acting as a distribution portal 220—may record the amount of time the user spends while interacting with the portal 220 by watching television. In this embodiment, the administrative system 110 may have strategic partnerships with one or more network television providers, who can reach virtually any home that receives over-the-air television, satellite television, cable television or internet-based television.

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the methods and systems of the present invention disclosed herein without departing from the spirit and scope of the invention.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the embodiments disclosed herein may be implemented as electronic hardware, computer software, or combinations of both. To illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array signal (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The methods disclosed herein comprise one or more steps or actions for achieving the described method. The method steps and/or actions may be interchanged with one another without departing from the scope of the present invention. In other words, unless a specific order of steps or actions is required for proper operation of the embodiment, the order and/or use of specific steps and/or actions may be modified without departing from the scope of the present invention.

While the systems and methods described herein may be implemented to permit a user to download media content with no out of pocket expense to the user, it is to be understood that the disclosure herein is broad enough to encompass systems and methods in which a user uses a combination of points accrued in his or her points bank as described herein and currency (e.g., cash, check, credit card, debit card, etc.) to download songs. For example, the user may use the points accrued in his or her points bank to obtain a discount on the fee the user would otherwise have to pay to download a copy of the media content or purchase a product from an advertiser. In other words, the disclosure is broad enough to cover systems and methods in which a user may incur out of pocket expense when downloading or otherwise copying media content.

It is to be understood that a person or entity may have multiple roles in the system and method as described herein. For example, a person may be a user 100 while at the same time providing media content for distribution through the system as a media content provider 130. As another example, an advertiser 120 may also be a media content provider 130. Nothing herein is intended to limit the roles that a person or entity can have within the systems and methods described herein.

While the system and methods herein have been described with respect to one distribution portal, the scope of the disclosure is not so limited. By way of example and not limitation, it is also possible within the scope of the present disclosure to provide more than one distribution portal 220 wherein a user's interactions with any of the distribution portals is tracked and his/her points bank credited or debited based on the user's interaction with any one of the distribution portals. Accordingly, a user may access a first distribution portal to interact with the media content on the first distribution portal while at the same time being exposed to one or more advertisements, but redeem the points the he accrued through the interaction with the first distribution portal for media content on a second distribution portal. In such an embodiment, the one or more distribution portals may choose to implement a system to enable a user to utilize a universal log-in, whereby the user logs-in once and his interactions on the various distribution portals are tracked and his/her points bank credited or debited as appropriate without the user having to log into the one or more distribution portals individually or one at a time.

It is also within the scope of the present disclosure to share a percentage of the advertising revenue generated with the owner of media content with which a user interacts but that a user does not download or copy to a device 210. For example, there may be some types of media content (e.g., news articles or blog postings) that may be very popular with users but that user's may not necessarily download to their device 210 after viewing the media content. To incentivize the owners of such media content to continue to produce and provide such media content, the owners of such media content may be provided with a percentage of the revenue generated through the display of advertisements while the user interacted with the media content. The same approach may be taken with respect to any media content (e.g., songs, television shows, movies, etc.) with which a user interacts but does not necessarily download or copy to a device 210.

We claim:

1. A method of displaying and charging for advertisements, comprising:
providing a portal for at least one user to interact with at least one media content;
displaying at least one advertisement on the portal for a predetermined amount of time in a manner that requires the advertisement to be viewable by the user while the user is interacting with the media content; and
charging a sponsor of the at least one advertisement a fee for the display of the advertisement as a function of the amount of time that the advertisement was displayed on the portal.

2. The method of claim 1, further comprising allowing the user to store the media content on a device after the user has interacted with the media content through the portal.

3. The method of claim 1, further comprising:
providing a account for recording the user's interactions with the media content;
recording the amount of time that the user spends interacting with the media content; and
crediting the account with points reflecting the amount of time that the user interacted with the media content.

4. The method of claim 1, wherein the fee for the display of the advertisement is further a function of the popularity of the media content.

5 The method of claim 1, wherein the portal is a web site.

6. The method of claim 1, wherein the portal is a television.

7. The method of claim 1, further comprising;
tracking demographic information relating to the at least one user;
customizing an information appearing on the portal based on the demographic information relating to the at least one user.

8. The method of claim 7, wherein the demographic information relating to the at least one user is a geographic location of the at least one user.

9. A method for the acquisition of at least one media content comprising:
using a device to access a portal;
selecting a media content for display through the portal on said device;
concurrently viewing the media content and at least one advertisement on a display of the device; and
receiving points in a points bank as a function of the amount of time spent viewing the media content.

10. The method of claim 9, further comprising downloading the media content for storage on the device.

11. The method of claim 9, further comprising exchanging the points in the points bank for currency.

12. A method of placing advertisements on a portal for the distribution of media content comprising:
registering with a portal wherein at least one user interacts with at least one media content;
selecting at least one advertisement to be displayed on the portal for a predetermined amount of time in a manner that requires one advertisement to be viewable by the at least one user while said user is interacting with the media content; and
paying an administrator of the portal a fee for the display of the advertisement as a function of the amount of time that the advertisement was displayed on the portal.

13 The method of claim 12, wherein the portal is a web site.

14. The method of claim 12, wherein the portal is a television.

15. The method of claim 12, selecting the at least one advertisement based on demographic information relating to the user.

16. The method of claim 15 wherein the demographic information relating to the user is the geographic location of said user.

17. A computer system for displaying and charging for advertisements, comprising:
a server for the storage and distribution of a media content; a server for the storage and distribution of an advertisement; a portal for transmitting the media content and the advertisement for concurrent display on a user's remote device; and a processor for tracking the amount of time that the advertisement was concurrently displayed on the remote device and for calculating an advertising fee to be charged to a sponsor of the advertisement.

18. The system of claim 17, further comprising a processor for tracking a geographic location of the remote device; and a processor for customizing an information appearing on the portal based on the geographic location of the remote device.

19. The system of claim 17, further comprising a processor for tracking demographic information relating to the user; and a processor for customizing an information appearing on the portal based on the demographic information relating to the user.

20. The system of claim 19 wherein the demographic information relating to the user is the geographic location of the user.

21. The system of claim 19, further comprising a storage medium for storing a profile information relating to the user, said profile information including demographic information relating to the user.

22. The system of claim 19, wherein the storage medium further stores a points bank associated with the user for tracking and recording the user's engagement with the portal.

23. A method for the distribution of at least one media content comprising:
providing a distribution portal for access by a remote device;
providing a media content for display through said distribution portal on said remote device;
concurrently displaying the media content and at least one advertisement on a display of the remote device; and
crediting a points bank as a function of the amount of time that the at least one advertisement is displayed on the display of the remote device.
